(19) United States
(12) Patent Application Publication
(10) Pub. No.: US 2002/0061268 A1
(43) Pub. Date: May 23, 2002

(54) Combustion engine assembly with a small volume catalytic converter

(76) Inventors: Rolf Bruck, Bergisch Gladbach (DE); Wolfgang Maus, Bergisch Gladbach (DE); Ludwig Wieres, Overath (DE)

Correspondence Address: LERNER AND GREENBERG, P.A., Post Office Box 2480, Hollywood, FL, 33022-2480, US

(21) Appl. No.: 10/014,265

(22) Filed: Nov. 7, 2001

Related U.S. Application Data
(63) Continuation of application No. PCT/EP00/03177, filed on Apr. 10, 2000.

(30) Foreign Application Priority Data
May 7, 1999 (DE) 199 21 263.5

(51) Int. Cl. B01J 8/02; B01J 35/02

(52) U.S. Cl. 422/211; 422/212; 422/218; 422/222

(57) ABSTRACT

A combustion engine assembly includes a combustion engine with a displacement and a downstream catalytic converter for cleaning exhaust gas. The catalytic converter has a geometric surface and an effectiveness for converting at least one harmful component in the exhaust gas into harmless components. The catalytic converter has at least one honeycomb body, all of which together have a total volume. The volume is selected in such a way that it is smaller than the displacement by a factor of 0.6. However, the geometric surface is dimensioned in such a way that the catalytic converter has an effectiveness of more than 98%. The honeycomb body is preferably a metallic honeycomb body formed of layered and/or wound and at least partly structured sheet metal layers. Channels of the honeycomb body are separated from one another by channel walls. An average thickness of the channel walls is at most 40 micrometers, preferably at most 35 micrometers and in particular between 18 and 32 micrometers. The number of channels of the honeycomb body over a cross-section through the body is at least 600 cpsi. Small volume, particularly cost-effective honeycomb bodies can be provided in this way.

### CROSS-REFERENCE TO RELATED APPLICATION

This application is a continuation of copending International Application No. PCT/EP00/03177, filed Apr. 10, 2000, which designated the United States.

### BACKGROUND OF THE INVENTION

1. Field of the Invention

The present invention relates to a combustion engine with a given displacement H and a downstream catalytic converter for cleaning exhaust gases. According to the legal requirements of most countries, it is normal to clean the exhaust gases from combustion engines through the use of a catalytic converter that is disposed in the exhaust system of the combustion engine.

The construction of exhaust gas cleaning systems in the past was mostly based on empirical evidence. In International Publication No. WO 91/01178, corresponding to U.S. Pat. No. 5,403,559, exhaust gas cleaning systems are described, for example, which are constructed from a plurality of honeycomb bodies, so that using the size and number of those honeycomb bodies, a desired catalytic converter area could be selected for any size of displacement in a combustion engine. It is important in that case, that in the end the exhaust gas is cleaned sufficiently for the legal requirements to be satisfied. That means that today in most countries more than 98%, and preferably even more than 99%, of the harmful content of the exhaust gas, in particular the hydrocarbon substances and/or nitrous oxide, are converted into harmless components. The effectiveness E is measured by using specific, pre-determined driving cycles or in specific operating conditions.

The criteria to be considered when constructing an exhaust gas cleaning system are quite numerous. Catalytic converters typically include honeycomb bodies, which have the task of making available a sufficiently large geometrical surface with which the exhaust gas to be cleaned comes into contact. The honeycomb bodies are generally provided with exhaust gas permeable channels that are separated from one another by walls. The geometric surface O is crucial to the effectiveness E of a catalytic converter. In principle, a specific desired geometric surface O can be obtained by enlargement of the number A of walls in a pre-determined volume, or by enlargement of the volume while having a pre-determined number A of walls per cross-sectional unit. The construction must also take into account the flow speed and flow characteristics in the channels which affect the effectiveness E, and the pressure loss in the exhaust gas flow caused by the catalytic converter. That loss influences the degree of efficiency of the combustion engine. Naturally, the layout of the cross-sectional shape of the honeycomb body depends on the type of catalytically active coating, the flow to the honeycomb body and other parameters.

As a result of further development of honeycomb bodies as carrier bodies for catalytically active material in a catalytic converter, the wall thicknesses of the channels are being reduced more and more, which has a positive effect on the pressure loss. The freedom in construction is ever greater because, with reduced wall thickness, ever smaller channels and ever larger geometric surfaces per volume unit can be produced, with an acceptable pressure loss. Nevertheless, the rules discovered empirically are still substantially retained, so that typically, with combustion engines, the volume of a downstream catalytic converter is on the same order of magnitude as the displacement.

### SUMMARY OF THE INVENTION

It is accordingly an object of the invention to provide a combustion engine assembly with a small volume downstream catalytic converter, which overcomes the hereinafore-mentioned disadvantages of the heretofore-known devices of this general type and in which the catalytic converter is constructed in such a way that it reaches a legally required high degree of effectiveness E, but has a significantly smaller volume V than a displacement H of the combustion engine, and can be manufactured more inexpensively.

With the foregoing and other objects in view there is provided, in accordance with the invention, a combustion engine assembly, comprising a combustion engine having a displacement H and emitting exhaust gases, as well as a catalytic converter disposed downstream of the combustion engine for cleaning the exhaust gases. The catalytic converter has at least one honeycomb body with a total volume V smaller than the displacement H by at least a factor of 0.6. The catalytic converter also has a geometric surface O dimensioned to provide the catalytic converter with an effectiveness E of more than 98% for converting at least one harmful component in the exhaust gases into harmless components.

These requirements are expressed by the following formulae:

(a) E>98%

(b) V<0.6H

This selection of parameters has, on one hand, the advantage that the catalytic converter requires only a relatively small volume, which facilitates its accommodation in the engine space and/or below the floor tray of a motor vehicle. Naturally, the geometric surface O per volume unit must be increased as compared to large volume catalytic converters, in order to obtain the necessary effectiveness E. While it was previously assumed that the thinner channel walls necessary for this increased the costs for manufacturing smaller volume honeycomb bodies with larger geometric surfaces, a precise analysis unexpectedly shows that this is not the case, as will be explained below, in particular with reference to honeycomb bodies manufactured from metallic foils.

In accordance with another feature of the invention, the number A of channels in the cross-section of the honeycomb body is at least 500 cpsi (cells per square inch).

In accordance with a further feature of the invention, the thickness d of the channels walls, which separate the channels from one another, must on average be at most 40 micrometers, preferably 35 micrometers, and is particularly between 18 and 32 micrometers.

(c) A>=500 cpsi

(d) d<40 micrometers

With metallic honeycomb bodies of layered and/or wound, at least partially structured, sheet metal layers, there is a relationship between the number A of channels per cross-sectional surface of the honeycomb body and the thickness d of the sheet metal layers. With relatively few channels per cross-sectional surface, the channels themselves have relatively large dimensions. Therefore, the channel walls have to be relatively thick so that they do not oscillate in the pulsating exhaust gas flow and become damaged in the long term. The smaller the channel cross-sections, the shorter the freely oscillating sections of the structured sheet metal layers which form the channel walls. The sheet metal layers can therefore be thinner without increasing the tendency to oscillate. This effect is very important for the present invention, since larger numbers A of channels per cross-sectional surface can only be implemented, while being mindful of undesirable pressure losses, when the channel walls are very thin.

For the sake of resistance to corrosion, only steel sheets with a high chromium and aluminum content are used for catalytic converters, which are relatively difficult to roll. Therefore, a person of skill in the art correctly assumed that the manufacturing costs for such steel foils would increase as the foil became thinner. However, as will be explained in more detail below with reference to FIG. 3, close examination shows that actually the price for the geometric surface O, upon which the effectiveness E of the catalytic converter substantially depends, becomes less as the number A of channels per cross-sectional unit in a honeycomb body becomes greater, when the thickness d of the foils is correspondingly reduced. The unexpected finding of the present invention is therefore that, at least for metallic honeycomb bodies, the costs for obtaining the necessary effectiveness of a catalytic converter are reduced as the ratio of the number A of channels per cross-sectional area to the volume V of the honeycomb body becomes greater, as long as in each case the thickness d of the foil is reduced to the extent possible as a result of the tendency to oscillate. While the price per liter of catalytic converter volume naturally increases in an almost linear manner with the number A of channels per cross-sectional unit in that volume, and therefore greater numbers A of channels would not necessarily be seen as cost effective, an increase in the number A of channels and a simultaneous reduction in the volume V is particularly advantageous.

In accordance with a concomitant feature of the invention, from these points of view, honeycomb bodies in particular with at least 600 cpsi, and an average thickness d of the channel walls of at the most 32 micrometers, are proposed.

Other features which are considered as characteristic for the invention are set forth in the appended claims.

Although the invention is illustrated and described herein as embodied in a combustion engine assembly with a small volume catalytic converter, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a fragmentary, diagrammatic, elevational view of a combustion engine with a downstream catalytic converter;

FIG. 2 is a fragmentary, partly broken-away, perspective view of a catalytic converter; and

FIG. 3 is a diagram respectively illustrating prices of volumes and of surfaces in a metallic honeycomb body, in dependence upon a number A of channels per cross-sectional unit.

### DESCRIPTION OF THE PREFERRED EMBODIMENTS

Referring now in detail to the figures of the drawings and first, particularly to FIG. 1 thereof, there is seen a combustion engine 1, downstream of which a catalytic converter 2 is provided. Typically, such a catalytic converter 2 is constructed from one or more honeycomb bodies and is disposed in an engine compartment or under a floor tray or pan of a motor vehicle.

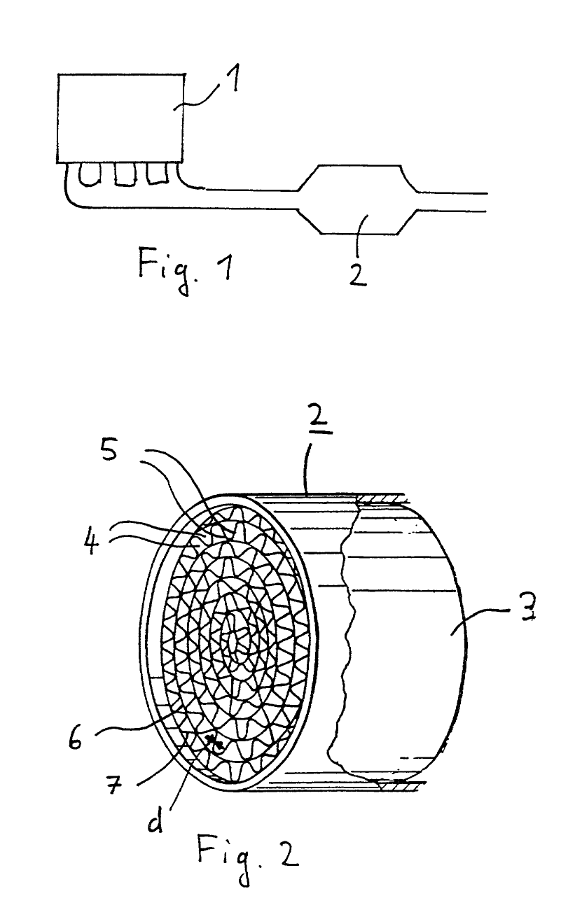

FIG. 2 shows a catalytic converter 2 which contains a honeycomb body 3. In the present embodiment of the invention, to which the invention is not limited, however, this honeycomb body 3 is constructed of alternating flat sheet metal layers 6 and corrugated sheet metal layers 7, which form channels 4. The sheet metal layers 6, 7 form channel walls 5 with an average thickness d. The sheet metal layers 6, 7 together form a geometric surface O of the honeycomb body 3. However, the sheet metal layers 6, 7 are coated with a ceramic, aluminum oxide based, so-called washcoat so that a very large porous surface is produced, which can be many times greater than the geometric surface O. A catalytically active substance, in particular a mixture of different noble metals, is applied to the non-illustrated washcoat.

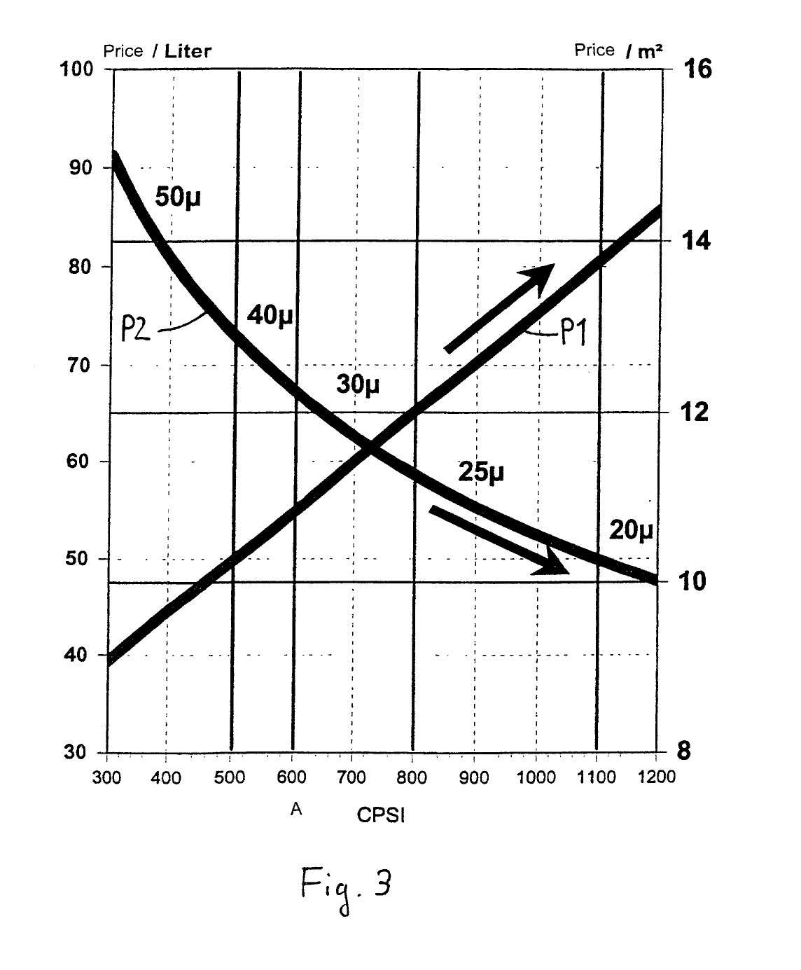

The diagram of FIG. 3 shows a number A of channels 4 per cross-sectional surface unit (cpsi) on the x-axis. A price per honeycomb body volume (price per liter) is shown on the left-hand side on the y-axis and a price per area (price per square meter) is shown on the right-hand side on the y-axis. Ranges in which the thicknesses d of metal foils typically available on the market can be used, are shown through the use of vertical lines. It is evident that metal foils having a thickness of 50 micrometers are particularly suitable for up to 500 cpsi, metal foils having a thickness of 40 micrometers are suitable for 500-600 cpsi, and metal foils having a thickness of 30 micrometers are suitable for 600-800 cpsi. Even thinner foils should be used for even larger numbers of channels per cross-sectional unit. A line P1 in the diagram shows how the price per liter increases with an increasing number A of channels 4 per cross-sectional unit. However, of more importance to the present invention is the fact that a curve P2 shows how the price per square meter decreases with an increasing number A of channels 4 per square meter. In the case of honeycomb bodies according to the invention, this means that while having the same geometric surface O, a smaller volume honeycomb body with a large number of channels is less expensive than a honeycomb body with a larger volume.

The present invention thus teaches the cost effective use of small volume catalytic converters with a large number A of channels 4 per cross-sectional surface. In particular, the invention teaches the use of metal foils having a thickness on average of approximately 25 micrometers, or even 20 micrometers, for honeycomb bodies with more than 800 cpsi and up to 1200 cpsi. With such honeycomb bodies, an effectiveness of 98%, preferably even 99% is obtained, even when a volume V of a catalytic converter 2 connected downstream of a combustion engine 1 is only half or less of a displacement H of the combustion engine 1.

Although particular embodiments of the invention have been described, it will be appreciated that many modifications, additions and/or substitutions may be made within the spirit and scope of the invention as defined in the appended claims.

We claim:

1. A combustion engine assembly, comprising:
a combustion engine having a displacement and emitting exhaust gases; and
a catalytic converter disposed downstream of said combustion engine for cleaning the exhaust gases;
said catalytic converter having at least one honeycomb body with a total volume smaller than said displacement by at least a factor of 0.6; and
said catalytic converter having a geometric surface dimensioned to provide said catalytic converter with an effectiveness of more than 98% for converting at least one harmful component in the exhaust gases into harmless components.

2. The combustion engine assembly according to claim 1, wherein said at least one honeycomb body has a cross-section and a number of channels through which exhaust gas can flow, said number of channels being at least 500 cpsi (cells per square inch) over said cross-section.

3. The combustion engine assembly according to claim 2, wherein said at least one honeycomb body is a metallic honeycomb body having at least one of layered and wound sheet metal layers being at least partly structured.

4. The combustion engine assembly according to claim 3, wherein said channels are separated from one another by channel walls having an average thickness of at most 40 micrometers.

5. The combustion engine assembly according to claim 3, wherein said channels are separated from one another by channel walls having an average thickness of at most 35 micrometers.

6. The combustion engine assembly according to claim 3, wherein said channels are separated from one another by channel walls having an average thickness of between 18 and 32 micrometers.

7. The combustion engine assembly according to claim 3, wherein said number of channels over said cross-section of said at least one honeycomb body is at least 600 cpsi, and said channels are separated from one another by channel walls having an average thickness of at most 32 micrometers.

8. The combustion engine assembly according to claim 3, wherein said catalytic converter is a three-way catalytic converter converting at least 98% of hydrocarbons and nitrous oxides in the exhaust gases during normal operation.

9. The combustion engine assembly according to claim 3, wherein said catalytic converter is a three-way catalytic converter converting 99% of hydrocarbons and nitrous oxides in the exhaust gases during normal operation.

10. The combustion engine assembly according to claim 3, wherein said number of channels of said at least one honeycomb body is more than 750 cpsi, and said volume is 0.5 times said displacement.

11. The combustion engine assembly according to claim 3, wherein said channels are separated from one another by channel walls having an average thickness of less than 32 micrometers.

12. The combustion engine assembly according to claim 3, wherein said channels are separated from one another by channel walls having an average thickness of approximately 25 micrometers.

13. The combustion engine assembly according to claim 2, wherein said channels are separated from one another by channel walls having an average thickness of at most 40 micrometers.

14. The combustion engine assembly according to claim 2, wherein said channels are separated from one another by channel walls having an average thickness of at most 35 micrometers.

15. The combustion engine assembly according to claim 2, wherein said channels are separated from one another by channel walls having an average thickness of between 18 and 32 micrometers.

16. The combustion engine assembly according to claim 2, wherein said number of channels over said cross-section of said at least one honeycomb body is at least 600 cpsi, and said channels are separated from one another by channel walls having an average thickness of at most 32 micrometers.

17. The combustion engine assembly according to claim 2, wherein said catalytic converter is a three-way catalytic converter converting at least 98% of hydrocarbons and nitrous oxides in the exhaust gases during normal operation.

18. The combustion engine assembly according to claim 2, wherein said catalytic converter is a three-way catalytic converter converting 99% of hydrocarbons and nitrous oxides in the exhaust gases during normal operation.

19. The combustion engine assembly according to claim 2, wherein said number of channels of said at least one honeycomb body is more than 750 cpsi, and said volume is less than 0.5 times said displacement.

20. The combustion engine assembly according to claim 2, wherein said channels are separated from one another by channel walls having an average thickness of less than 32 micrometers.

21. The combustion engine assembly according to claim 2, wherein said channels are separated from one another by channel walls having an average thickness of approximately 25 micrometers.

22. The combustion engine assembly according to claim 1, wherein said at least one honeycomb body is a metallic honeycomb body having at least one of layered and wound sheet metal layers being at least partly structured.

23. The combustion engine assembly according to claim 22, wherein said channels are separated from one another by channel walls having an average thickness of at most 40 micrometers.

24. The combustion engine assembly according to claim 22, wherein said channels are separated from one another by channel walls having an average thickness of at most 35 micrometers.

25. The combustion engine assembly according to claim 22, wherein said channels are separated from one another by channel walls having an average thickness of between 18 and 32 micrometers.

26. The combustion engine assembly according to claim 22, wherein said number of channels over said cross-section of said at least one honeycomb body is at least 600 cpsi, and said channels are separated from one another by channel walls having an average thickness of at most 32 micrometers.

27. The combustion engine assembly according to claim 22, wherein said catalytic converter is a three-way catalytic converter converting at least 98% of hydrocarbons and nitrous oxides in the exhaust gases during normal operation.

28. The combustion engine assembly according to claim 22, wherein said catalytic converter is a three-way catalytic converter converting 99% of hydrocarbons and nitrous oxides in the exhaust gases during normal operation.

29. The combustion engine assembly according to claim 22, wherein said number of channels of said at least one honeycomb body is more than 750 cpsi, and said volume is less than 0.5 times said displacement.

30. The combustion engine assembly according to claim 22, wherein said channels are separated from one another by channel walls having an average thickness of less than 32 micrometers.

31. The combustion engine assembly according to claim 22, wherein said channels are separated from one another by channel walls having an average thickness of approximately 25 micrometers.

32. The combustion engine assembly according to claim 1, wherein said catalytic converter is a three-way catalytic converter converting at least 98% of hydrocarbons and nitrous oxides in the exhaust gases during normal operation.

33. The combustion engine assembly according to claim 1, wherein said catalytic converter is a three-way catalytic converter converting 99% of hydrocarbons and nitrous oxides in the exhaust gases during normal operation.

34. The combustion engine assembly according to claim 1, wherein said number of channels of said at least one honeycomb body is more than 750 cpsi, and said volume is less than 0.5 times said displacement.

35. The combustion engine assembly according to claim 1, wherein said channels are separated from one another by channel walls having an average thickness of less than 32 micrometers.

36. The combustion engine assembly according to claim 1, wherein said channels are separated from one another by channel walls having an average thickness of approximately 25 micrometers.

37. The combustion engine assembly according to claim 32, wherein said number of channels of said at least one honeycomb body is more than 750 cpsi, and said volume is less than 0.5 times said displacement.

38. The combustion engine assembly according to claim 37, wherein said channels are separated from one another by channel walls having an average thickness of less than 32 micrometers.

39. The combustion engine assembly according to claim 37, wherein said channels are separated from one another by channel walls having an average thickness of approximately 25 micrometers.
